(19) United States
(12) Patent Application Publication
(10) Pub. No.: US 2004/0214704 A1
(43) Pub. Date: Oct. 28, 2004

(54) Apparatus for forming shipping containers

(76) Inventors: Jeffrey M. Gardner, West Chicago, IL (US); Nicholas A. Philips, Sugar Grove, IL (US)

Correspondence Address: WEYERHAEUSER COMPANY, INTELLECTUAL PROPERTY DEPT., CH 1J27, P.O. BOX 9777, FEDERAL WAY, WA, 98063, US

(21) Appl. No.: 10/423,742

(22) Filed: Apr. 24, 2003

(51) Int. Cl. B31B 1/25

(52) U.S. Cl. 493/59

(57) ABSTRACT

Bliss-type boxes made by combining containerboard body blanks with end panel or box liner blanks. The invention is a Bliss box former in direct association with a slitter/scorer. The slitter/scorer is supplied with containerboard sheets having a width which is equal to the length of the box liner blanks. The sheets have a length which is equal to a whole number multiple of the width of the box liner blanks. No waste is created. Box liners are severed and scored for delivery as needed by the Bliss box former. By combining the slitter/scorer with the Bliss former the need for maintaining multiple sizes of box liner blanks in inventory is reduced and setup when boxes are being made that differ only in width is greatly simplified.

The present invention is an apparatus for forming Bliss-type shipping containers without the need for supplying precut end blanks. The apparatus is particularly well suited for forming two piece body wrap-type Bliss boxes.

### BACKGROUND OF THE INVENTION

So-called Bliss boxes are a general type well known in the shipping container industry. They are formed from multiple pieces of corrugated container board glued together to form a single unit. Typically, one piece forms the bottom, side walls, and the major top flaps. This is generally called the body portion. Separate pieces are glued in to form the end walls and minor top flaps, if any. One variation of this is called a body wrap box. In this type both end portions are formed from a wrapped around single piece or “box liner” which usually overlies (but may also underlie) the body blank forming the bottom and sides of the box. An example of Bliss-type boxes and equipment for forming them is well described in U.S. Pat. No. 4,197,789 to Moen. Normally precut and scored body and end or box liner blanks are delivered to the former. When size changes are necessary, the equipment must be shut down and major adjustments made. This applies to not only to the box former but also the slitters and die cutters forming the body and end blanks which are formed from the large sheets delivered from the corrugator. The multi-component construction of Bliss boxes enables corrugated containerboard of different weights to be used in the most critical stress bearing areas. As an example, the sides and bottom portion might be made of heavier weight board then the ends or vice versa. Typically the Bliss box former will be at a customer's location where the boxes are ultimately filled with product. The producer of the corrugated board supplies precut and scored blanks which must then be held in inventory, often in multiple sizes.

Occasionally it is desired to fill an order of boxes that differ in only a single dimension; e.g., width. In the past this has still required the time consuming changes noted above. The present invention is beneficial in that it reduces the time and complexity of making setup changes where single dimensions are being changed. In addition, it eliminates the need for the end or box liner pieces of several sizes to be held in inventory.

### SUMMARY OF THE INVENTION

It should be understood that some of the terms used in the following description are relative; e.g., length, width, and depth and bottom and sides can sometimes be used interchangeably, depending on the particular box construction. A score or score line is a linear indentation formed in a corrugated board container blank at a location which will later be bent as a container is formed. A container blank is a flat piece of board of appropriate outline and scoring pattern which is used for subsequent formation of a container. Bliss-type boxes have many style variations but all are of multi-component construction. By multi-component is meant that at least two differently configured container blanks are required and are glued together during assembly.

The present invention is directed to equipment forming a Bliss-type corrugated shipping container. It is particularly directed to equipment for formation of a two piece body wrap-type box. A first component is a conventional Bliss box former. The type described in U.S. Pat. No. 4,197,789 may be mentioned as a non-limiting example. This is supplied in conventional fashion with a stack of precut and scored container board body blanks which are then singulated for formation of individual boxes. In past practice the blanks for the end or box liner portions of the boxes would also be separately precut and scored and then delivered in stacks to the Bliss former. However, it has now been found highly advantageous to have a dedicated slitter/scorer directly coupled to the Bliss former. The slitter/scorer forms the box liner blanks for the ends as needed. A supply of containerboard sheets is delivered to the slitter/sorter from the corrugator. These sheets most preferably have a width dimension that is identical with the required length dimension of the box liner blanks. Further, the sheets most preferably have a length dimension that is a whole number multiple of the required width dimension of the box liner blanks. The sheets of corrugated board are fed singly into the slitter/scorer where the box liner blanks are severed and scored for delivery to the Bliss former. The slitter in this application has only the need to make a transverse cut across the sheet. In the Bliss former the body blanks and box liner blanks are combined and glued into Bliss-type boxes.

Many different types of Bliss box formers and slitter/scorers are suitable for combination to form the present apparatus. The invention is not in any way limited to any single type.

On some occasions it is necessary to form boxes that may differ in a single length or width dimension. When the length of the sheets supplied for forming the box liner blanks are whole number multiples of the desired container widths, the only change needed is to reset the Bliss former and slitter to the different width. This greatly simplifies and reduces the time and container blank inventory previously necessary for making dimension changes.

It is an object of the invention to provide an apparatus for preparing Bliss-type corrugated shipping containers.

It is an important object to provide an integrated Bliss box former and slitter/scorer for making the shipping containers.

It is yet an object to provide apparatus in which the box liner blanks for the boxes are formed as needed from a supply of larger sheets.

These and many other objects will become readily apparent upon reading the following detailed description taken in conjunction with the drawings.

### BRIEF DESCRIPTION OF THE DRAWINGS

FIG. 1 shows in plan view the two components of a body wrap Bliss box.

FIG. 2 is a diagrammatic plan view of a Bliss box former with an adjacent slitter/scorer supplying the box end panels.

### DETAILED DESCRIPTION OF THE PREFERRED EMBODIMENTS

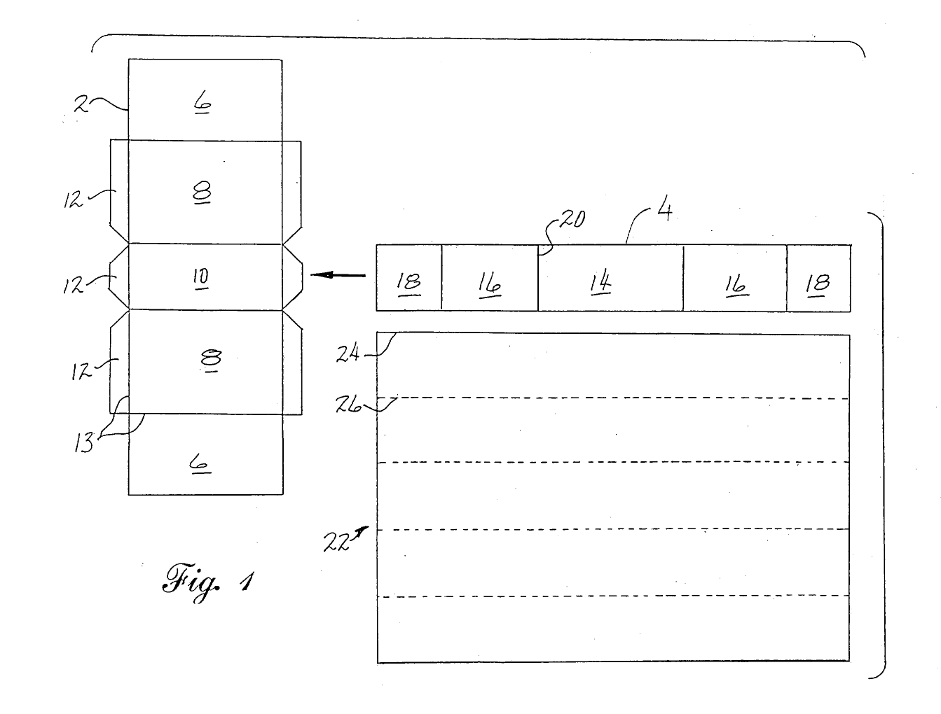

The invention can now be readily understood by reference to the drawings. FIG. 1 shows in plan view the two components of a body wrap-type Bliss box. The precut and scored body panel is seen at 2 and a scored end panel at 4. The body wrap panel has upper major flaps 6, side panels 8, and a bottom panel 10. Flanges 12 serve for adhesively uniting the body wrap panel to the box liner forming the ends. Score lines 13 indicate where folds will be made when the box is assembled. Box liner 4 has section 14 which will overlie bottom section 10 of body panel 2. It further has panels 16 which will become the box ends and panels 18 which are the upper minor flaps. The box liners have score lines 20 along which folds will be made when the box is assembled. Box liner 4 has been severed from a larger sheet 22 along cut line 24. Additional box liners will be cut along lines 26 as they are needed for assembly of subsequent boxes. It will be noted that the width of sheets 22 is identical to the length of box liners 4. Further, the length of sheets 22 is equal to a whole number multiple of the width of box liners 4. While this is not absolutely essential, it is highly desirable if no waste is to be created.

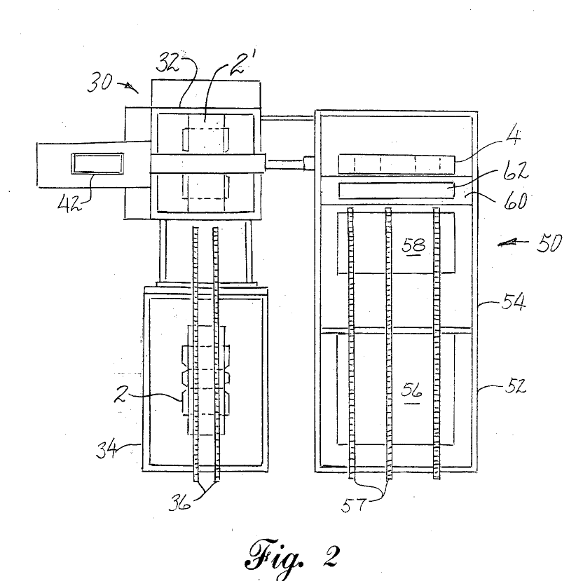

FIG. 2 is a diagrammatic plan representation of the combination of a Bliss box former, generally shown at 30, in combination with a slitter/scorer 50 which will create and supply the box liners 4. The box former itself is represented at 32. It contains an infeed section 34 which has a stack of precut and body blanks 2. These are transported to the box former by conveyor chains 36. Body blank 2′ is in position in box former 32 where it will be united with a box liner 4. Finished boxes 42 leave the former. The slitter scorer 50 has a storage zone 52 and a transport zone 54. The storage area receives loads of paperboard sheets 56 from the corrugator. These have most preferably been cut to a width equal to the length of the box liners 4. The length of sheets 56 should most preferably be a whole number multiple of the width of end panels 4. Corrugated sheets 56 are singulated and moved by conveyor chains 57 to the transport zone 54. Here the individual box liners are transversely severed from sheets 58 and scored at location 60, an area not shown in detail on the drawing. One such severed panel 62 is seen in place ready to be scored and transported to the next station where it will be moved, as needed, to the Bliss box former 30.

The present invention has the major advantage that the box liners forming the end panels need not be precut, scored, and held in inventory as is the usual practice. The need for a large inventory of box liners of different sizes is eliminated. This improves overall speed of the assembly operation. It has the additional advantage that boxes of different widths can be formed with minimal setup adjustment as long as the widths have a whole number relationship to the length of panels 56.

It will be immediately apparent that many variations not described herein are possible. Bliss-type boxes of many different sizes and styles can be formed with the present apparatus. It is the intention of the inventors that these should be included within the broad scope of the invention if encompassed within the following claims.

1. Equipment for forming a Bliss-type corrugated shipping container comprising a Bliss box former in direct combination with a slitter scorer, the container being formed from a preformed cut and scored body blank and a box liner blank, the slitter scorer providing the box liner blanks, the slitter/scorer receiving a stack of corrugated containerboard sheets, singulating the sheets, advancing the sheets to a station where box liner blanks are cut and scored, and delivering the box liners to the Bliss former for combination with the body blank.

2. The container forming equipment of claim 1 in which the corrugated sheets supplied to the slitter/scorer have a width which is equal to the length of the box liner blanks and a length which is a whole number multiple of the width of the box liner blanks.
